(19) United States
(12) Patent Application Publication
(10) Pub. No.: US 2011/0129140 A1
(43) Pub. Date: Jun. 2, 2011

(54) DEFECT REVIEW DEVICE, DEFECT REVIEW METHOD, AND DEFECT REVIEW EXECUTION PROGRAM

(76) Inventors: Masahiro Kitazawa, Honjo (JP); Mitsuji Ikeda, Hitachinaka (JP)

(21) Appl. No.: 13/055,870

(22) PCT Filed: Jun. 29, 2009
(86) PCT No.: PCT/JP2009/061823

§ 371 Date: Jan. 25, 2011

(30) Foreign Application Priority Data
Jul. 28, 2008 (JP) 2008-193661

(51) Int. Cl. G06K 9/00

(52) U.S. Cl. 382/149

(57) ABSTRACT

Provided is a defect review device enabling identification of a defect and a defect coordinate 33. The defect review device comprises a distance inspection image generation unit 5 for generating, on the basis of an inspection image 28, a distance inspection image 29 in which distance values between pixels constituting the contour of an actual pattern 28a and pixels lying in a direction normal to the contour are set in respect of the individual pixels, a distance design image generation unit 6 for generating a distance design image 27 in which values between pixels constituting the contour of a design pattern 26a corresponding to the actual pattern 28a and pixels lying in a direction normal to the contour are set in respect of the individual pixels, a distance difference image generation unit 9 for generating a distance difference image 30 in which differences in distance value between the distance design image 27 and the distance inspection image 29 are set in respect of the individual pixels, and a defect coordinate identifying unit 10 for identifying, on the basis of the distance difference image 30, a defect coordinate 33 at which a defect 28b takes place.

### TECHNICAL FIELD

The present invention relates to a defect review device and a defect review method for reviewing a defect on the basis of an inspection image and a defect review execution program.

### BACKGROUND ART

Minute patterns are formed in a semiconductor device and a display. By making a pattern minute, not only the chip area can be reduced to decrease fabrication costs but also the performance of the semiconductor device and the like can be improved. Therefore, further miniaturization has been contrived

As the pattern minuteness advances, a defect such as a small-size foreign matter becomes responsible for a defective operation in the semiconductor device or the like. Since improvements in the integration degree of patterns concomitant with the miniaturization will increase time necessary for inspection and raise fabrication costs, the time necessary for inspection is required to be shortened.

Generally, defects such as burnout, short circuit, foreign matter and electric potential contrast defect are generated in the semiconductor device or the like. In the procedures of inspecting these defects, a position on a substrate such as a semiconductor wafer where an objective deemed as a defect exists (called a defect candidate coordinate) is first detected by using an appearance inspection apparatus or a foreign matter inspection apparatus. Next, an inspection image is acquired by using a defect review device which is focused on the defect candidate coordinate to pick it up at a high-magnification. On the basis of the inspection image, detection and observation of the defect, called review, is carried out to analyze causes of generation of the defect and to classify the defect (candidate coordinate) factor by factor.

For detection of the defect from the defect candidate coordinate, a method called a die-comparison is available. After a position in an adjacent chip (die) being same as the defect candidate coordinate has been photographed to provide a reference image, a position at the defect candidate coordinate in a chip (die) to be inspected is photographed to provide an inspection image. An image of a difference in pixel values between the reference image and the inspection image is prepared and a coordinate having a large difference is determined as defect coordinate where the defect is positioned, thereby detecting the defect.

Further, a contrivance has been made in which a design pattern based on design data of a semiconductor device or the like and substituting for the reference image is compared with an actual pattern to detect a defect (see PATENT DOCUMENT 1, for instance). A method has also been known according to which edge portions of a design pattern and an actual pattern are extracted and a defect is determined from edge portions which cannot correspond with each other.

Furthermore, a method has been proposed in which with the aim of evaluating a change in shape of an actual pattern, an image of the distance between the actual pattern and a design pattern is generated and the degree of coincidence of the shape of an inspection image with a shape which takes into account a permissible range determined from a design pattern is calculated on the basis of the distance image and position matching is carried out (see PATENT DOCUMENTS 2 and 3, for example).

### CITATION LIST

### Patent Literature

PATENT LITERATURE 1: JP Patent No. 3524853
PATENT LITERATURE 2: JP-A-2006-275952
PATENT LITERATURE 3: JP-A-2007-305118

### SUMMARY OF THE INVENTION

### Technical Problem

The defect coordinate and the defect candidate coordinate are coordinates of the same defect and ought to be coincident with each other in principle but the defect candidate coordinate lies in a wide range to have a coordinate of less significant figure number whereas the defect coordinate is in a narrow range to have a coordinate of much significant figure number, so that a difference takes place between the defect coordinate and the defect candidate coordinate. More specifically, even when an inspection image is photographed at a high magnification at a defect candidate coordinate, a defect will not sometimes be picked up at the defect candidate coordinate on the inspection image. Accordingly, much time will sometimes be consumed to identify the defect.

An object of the present invention is therefore to provide a defect review device and a defect review method which can identify a defect and a defect coordinate and a defect review execution program as well.

### Solution to Problem

To accomplish the above object according to the present invention, in a defect review device, a defect review method and a defect review execution program, a distance inspection image is generated, on the basis of an inspection image, in which distance values between pixels constituting the contour of an actual pattern and pixels lying in a direction normal to the contour are set in respect of the individual pixels, a distance design image is generated in which distance values between pixels constituting the contour of a design pattern corresponding to the actual pattern and pixels arranged in a direction normal to the contour are set in respect of the individual pixels, a distance difference image is generated in which differences in the distance values between the distance design image and the distance inspection image are set in respect of the individual pixels, and a defect coordinate at which a defect takes place is identified on the basis of the distance difference image.

### ADVANTAGEOUS EFFECTS OF THE INVENTION

According to the present invention, a defect review device, a defect review method and a defect review execution program which can identify a defect and a defect coordinate can be provided.

Other objects, features and advantages of this invention will become apparent from the following description of embodiments of the invention taken in conjunction with the accompanying drawings.

### BRIEF DESCRIPTION OF THE DRAWINGS

FIG. 1 is a block diagram of a defect review device according to an embodiment of the invention.

FIG. 2 is a flowchart in a defect review method according to an embodiment of the invention.

FIG. 3 is a diagram illustrating the configuration of a defect review device according to an embodiment of the invention.

FIG. 4 is a diagram showing an appearance of the defect review device according to the embodiment of the invention.

FIG. 5 is a diagram showing the configuration of a defect review system according to an embodiment of the invention.

FIG. 6 is a block diagram of a defect review device in which constituents necessary for carrying out a defect review method to be explained in embodiment 1 are extracted.

FIG. 7A shows an example of a design pattern image in the flow of execution of the defect review method in embodiment 1.

FIG. 7B shows an example of a distance design image in the same defect review method.

FIG. 7C shows an example of an inspection image in the same defect review method.

FIG. 7D shows an example of a distance inspection image in the same defect review method.

FIG. 7E shows an example of a distance difference image in the same defect review method.

FIG. 7F shows a binary-digitized image extracting a defect coordinate in the same defect review method.

FIG. 8A shows an example of an inspection image in which an actual pattern is picked up in the flow of generation of the distance inspection image in the defect review method to be explained in embodiment 1.

FIG. 8B shows an example of a graph of a distribution of frequencies (the number of pixels) versus pixel values in the inspection image in generation of the distance inspection image.

FIG. 8C shows an example of a binary-digitized image in generation of the distance inspection image.

FIG. 8D shows an example in which a reference distance value (the contour of an actual pattern) is set in an initialized distance inspection image in generation of the distance inspection image.

FIG. 8E shows an example in which a distance value is set internally of pixels (the contour of the actual pattern) set with the reference distance value in the distance inspection image in generation of the distance inspection image.

FIG. 8F shows an example in which a distance value is set externally of pixels (the contour of the actual pattern) set with the reference distance value in the distance inspection image in generation of the distance inspection image.

FIG. 9 shows a display screen (first) to be displayed on a display unit of the defect review device to be explained in embodiment 1.

FIG. 10 shows a display screen (second) to be displayed on a display unit of the defect review device to be explained in embodiment 1.

FIG. 11 is a block diagram of a defect review device in which constituents necessary for carrying out a defect review method (VC defect detection) to be explained in embodiment 2 are extracted.

FIG. 12A shows an example of an inspection image in which an actual pattern suffering from VC defects in the form of a reflected electron image is picked up in the flow of generation of a VC defect distance inspection image in the defect review method to be explained in embodiment 2.

FIG. 12B shows an example of an inspection image in which an actual pattern suffering from VC defects in the form of a secondary electron image is picked up in generation of the VC defect distance inspection image.

FIG. 12C shows an example of a graph of a distribution of frequencies (the number of pixels) versus pixel values in the inspection image in generation of the VC defect distance inspection image.

FIG. 12D shows an example of a VC defect binary-digitized image in which pixels corresponding to a VC defect are extracted in generation of the VC defect distance inspection image.

FIG. 12E is an enlarged diagram of the neighbor of an actual pattern suffering from the VC defect of FIG. 12D diagrammatically illustrated by emphasizing a pixel in generation of the VC defect distance inspection image.

FIG. 12F shows an example in which a predetermined distance value is set to pixels corresponding to a VC defect in the initialized VC defect distance inspection image in generation of the VC defect distance inspection image.

FIG. 13 is a block diagram of a defect review device in which constituents necessary for carrying out a defect review method (detection of pixel values on the contour line of distance values) to be explained in embodiment 3.

FIG. 14A shows an example of an inspection image in a drawing for explaining the flow of execution of embodiment 3 and an example of a graph of pixel values in inspection image which correspond to positions on the contour line of distance values.

FIG. 14B shows an example of a distance design image generated from a design pattern image in the defect review method.

FIG. 15A shows an example of an inspection image in a drawing for explaining the flow of execution of a defect review method (position matching between images) to be explained in embodiment 4.

FIG. 15B shows an example of a distance inspection image in the defect review method.

FIG. 15C shows an example of a distribution tendency binary-digitized image indicating a tendency which is characteristic of a distribution of distance values.

FIG. 15D shows an example of a design pattern image in the defect review method.

FIG. 15E shows an example of a distance design image.

FIG. 15F shows an example of a distribution tendency binary-digitized design image indicating a tendency which is characteristic of a distribution of distance values.

FIG. 15G shows an example of position matching between the distance inspection image and the distance design image.

FIG. 16A shows an example of an inspection image in which an actual pattern is picked up in a drawing for explaining the reason for identification of an erroneous defect coordinate when design data with optical proximity correction (OPC) is used.

FIG. 16B shows an example of a design pattern image without OPC in the drawing for explaining the reason for identification of the erroneous defect coordinate.

FIG. 16C shows an example of a design pattern image with OPC in the drawing for explaining the reason for identification of the erroneous defect coordinate.

FIG. 16D shows an example of an image displaying a difference pattern between an actual pattern and a design pattern with OPC in the drawing for explaining the reason for identification of the erroneous defect coordinate.

FIG. 17A shows an example of a distance design image having pixels on the contour of a design pattern set with reference distance values in a drawing for explaining the flow of execution of a defect review method (elimination of OPC) to be explained in embodiment 5.

FIG. 17B shows an example of a distance design image in which reference distance values are set to such pixels as being one pixel internal of the pixels set with the reference distance values in distance design image of FIG. 17A in the defect review method.

FIG. 17C shows an example of a distance design image in which reference distance values are set to such pixels as being one pixel internal of the pixels set with the reference distance values in distance design image of FIG. 17B in the defect review method.

FIG. 17D shows an example of a distance design image in which reference distance values are set to such pixels as being one pixel internal of the pixels set with the reference distance values in distance design image of FIG. 17C in the defect review method.

FIG. 17E shows an example of a distance design image in which the innermost ones of the pixels set with reference distance values in distance design image of FIG. 17D are set with a distance value smaller by one distance value than that of a one pixel internal pixel and the OPC is eliminated in the defect review method.

FIG. 17F shows an example of a distance design image in which the innermost ones of the pixels set with reference distance values in distance design image of FIG. 17E are set with a distance value smaller by one distance value than that of a one pixel internal pixel and the OPC is eliminated in the defect review method.

FIG. 17G shows an example of a distance design image in which the innermost ones of the pixels set with reference distance values in distance design image of FIG. 17F are set with a distance value smaller by one distance value than that of a one pixel internal pixel and the OPC is eliminated in the defect review method.

### DESCRIPTION OF EMBODIMENT

Next, embodiments of the present invention will be described in greater detail by making reference to the drawings as necessary. In the individual drawings, components in common are designated by the same reference numerals and will not be described in prolixity.

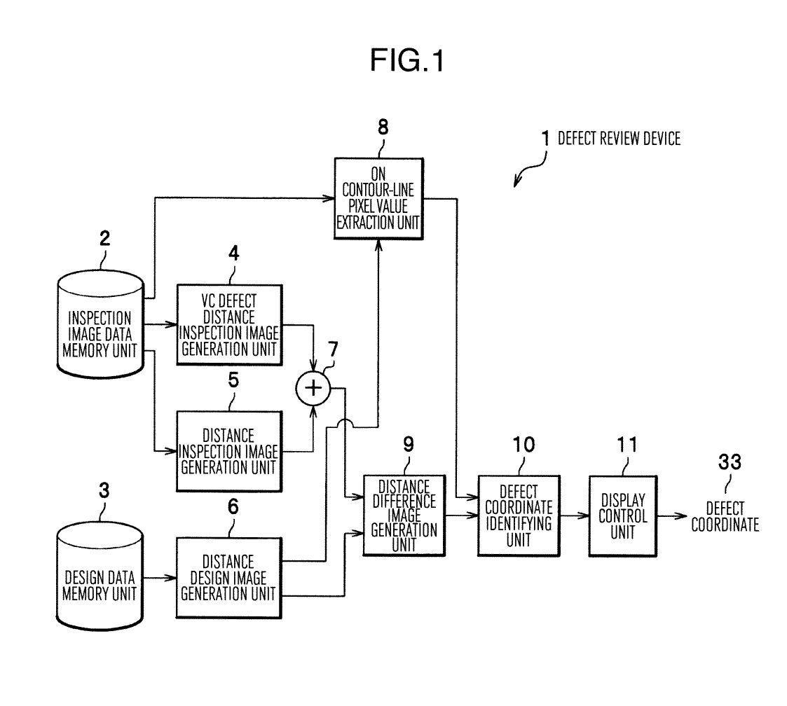

Illustrated in FIG. 1 is a block diagram of a defect review device 1 according to an embodiment of the present invention. The defect review device 1 comprises an inspection image data memory unit 2 for storing an inspection image obtained by photographing an actual pattern formed in a semiconductor device, a display or the like and a design data memory unit 3 for storing design data corresponding to the actual pattern and on which fabrication of the actual pattern is based. It will be appreciated that the design data memory unit 3 may have design data of the whole of the semiconductor device or on the basis of a defect candidate coordinate related to the actual pattern, the defect candidate coordinate and design data lying in its neighbor may be cut out to provide design data corresponding to the actual pattern.

The defect review device 1 also comprises a distance inspection image generation unit 5, a distance design image generation unit 6, a distance difference image generation unit 9, a defect coordinate identifying unit 10 and a display control unit 11. On the basis of an inspection image, the distance inspection image generation unit 5 sets distance values between pixels constituting the contour of an actual pattern and pixels lying in a direction normal to the contour in respect of the individual pixels. The distance design image generation unit 6 generates a distance design image in which distance values between pixels constituting the contour of a design pattern formed by drawing design data corresponding to the actual pattern and pixels lying in a direction normal to the contour are set in respect of the individual pixels. The distance difference image generation unit 9 generates a distance difference image in which differences in distance value between the distance design image and the distance inspection image are set in respect of the individual pixels. The defect coordinate identifying unit 10 identifies a defect coordinate 33 at which a defect takes place. The display control unit 11 superimposes the distance difference image and/or the defect coordinate 33 on the inspection image and/or the design pattern and causes the resultant image to be displayed on the display unit not shown.

The defect review device 1 also comprises an on contour-line pixel value extraction unit 8 for extracting consecutive pixels of equidistant value in the distance design image, that is, for extracting pixel values of pixels in the inspection image corresponding to pixels on a so-called contour line. Then, the defect coordinate identifying unit 10 identifies the defect coordinate 33 on the basis of the extracted pixel value.

The defect review device 1 also comprises a VC defect distance inspection image generation unit 4 and an adder 7. The VC defect distance image generation unit 4 extracts, on the basis of the inspection image, pixels corresponding to an actual pattern having a difference in electric potential contrast from another actual pattern and generates a VC defect distance inspection image in which a predetermined distance value is set to the extracted pixels. The adder 7 adds the distance value of distance inspection image to the distance value of VC defect distance inspection image in respect of each of the pixels to thereby update the distance inspection image. It will be appreciated that when processing images, the resolution may be lowered by merging four pixels into one or the resolution may be raised by dividing one pixel into four, for example.

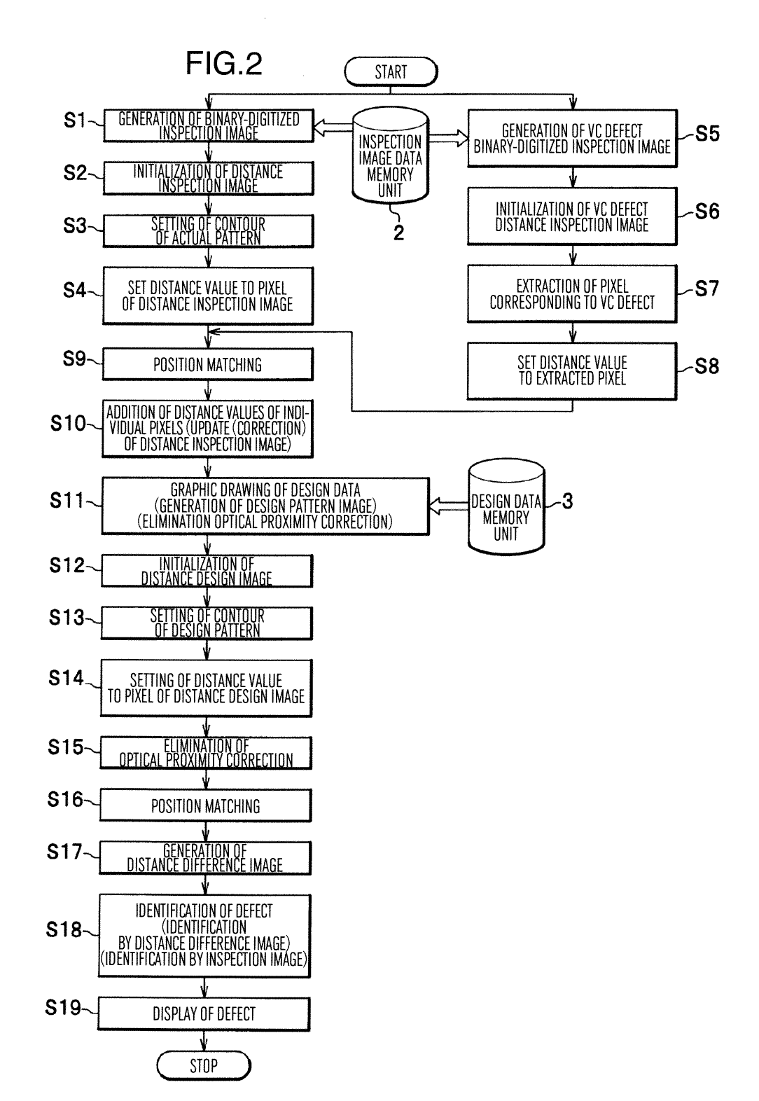

A flowchart of the defect review method according to the embodiment of the invention is shown in FIG. 2.

Firstly, the distance inspection image generation unit 5 reads, in step S1, an inspection image out of the inspection image data memory unit 2 and generates a binary-digitized image on the basis of the inspection image. The inspection image is obtained when an electron microscope to be described later provided for the defect review device 1 picks up, on the basis of a defect candidate coordinate to be described later, the defect candidate coordinate and its neighbor. Photographed in the inspection image is a circuit pattern (actual pattern) of a semiconductor device or the like.

In step S2, the distance inspection image generation unit 5 initializes the distance inspection image by setting initial values to all pixels of the distance inspection image.

In step S3, the distance inspection image generation unit 5 sets, on the basis of the binary-digitized image, the contour of the actual pattern to the distance inspection image. Specifically, a reference distance value is set as distance value to pixels positioned on the contour of the distance inspection image.

In step S4, the distance inspection image generation unit 5 sets, on the basis of the reference distance value, distance values to all of residual pixels of the distance inspection image. The distance value indicates essentially how many pixels intervene between a pixel set with the reference distance value and a target pixel in a direction normal to the contour, a pixel internal of the actual pattern is set with a distance value obtained by adding the number of pixels (distance) from the contour to the reference distance value and a pixel external of the actual pattern is set with a distance value obtained by subtracting from the reference distance value the number of pixels (distance) from the contour.

In step S5, the VC defect distance inspection image generation unit 4 reads an inspection image in the form of a secondary electron image out of the inspection image data memory unit 2 and generates a VC defect binary-digitized image on the basis of the inspection image.

In step S6, the VC defect distance inspection image generation unit 4 initializes the VC defect distance inspection image by setting initial values to all of pixels of the VC defect distance inspection image.

In step S7, the VC defect distance image generation unit 4 extracts, on the basis of the VC defect binary-digitized image, pixels corresponding to an actual pattern (VC defect) having a difference in electric potential contrast from another actual pattern.

In step S8, the VC defect distance inspection image generation unit 4 sets a predetermined distance value (to be set in excess of a difference binary-digitized threshold value to be described later) to the extracted pixel. It should be understood that not only step S5 to step S8 can be executed in parallel with step S1 to step S4 as shown in FIG. 2 but also either of them may precede the other.

In step S9, on the basis of the inspection image, the adder 7 performs position matching between the distance inspection image and the VC defect distance inspection image.

In step 10, the adder 7 adds a distance value of a corresponding pixel of the VC defect distance inspection image to a distance value of each pixel of the distance inspection image (addition) to thereby update (correct) the distance inspection image. To add, step S5 to step S10 may be omitted. If omitted, the program may proceed from step S4 to step S11.

Next, in step S11, the distance design image generation unit 6 reads design data corresponding to the actual pattern photographed in the form of the inspection image out of the design data memory unit 3, draws the read-out design data into a graphic form, thus generating a design pattern and further a design pattern image.

In case the generated design pattern contains the optical proximity correction, the optical proximity correction may be eliminated in step S11 but it may be eliminated in step S15 to be described later. When eliminating the optical proximity correction in step S11, the optical proximity correction can be eliminated easily through conventionally used reduction/enlargement of the design pattern.

In step S12, the distance design image generation unit 6 initializes the distance design image by setting initial values to all of pixels of the distance design image.

In step S13, the distance design image generation unit 6 sets, on the basis of the design pattern image or the binary-digitized design image, the contour of the design pattern to the distance design image. Specifically, a reference distance value is set as distance value to pixels positioned at the contour of the distance design image. The reference distance value set in step S13 is so set as to be equal to the reference distance value set in the step S3.

In step S14, the distance design image generation unit 6 sets distance values to all of residual pixels of the distance design image on the basis of the reference distance value as in the step S4.

In step S15, the distance design image generation unit 6 eliminates the optical proximity correction from the distance design image, though its details will be described later.

In step S16, the distance difference image generation unit 9 performs position matching between the distance design image and the distance inspection image, though its details will be described later.

In step S17, the distance difference image generation unit 9 calculates differences in distance value between pixels of the distance design image and pixels corresponding thereto of the distance inspection image, thus generating a distance difference image.

In step S18, the defect coordinate identifying unit 10 identifies, on the basis of the distance difference image, which position inside the inspection image a defect lies at. Namely, a defect coordinate 33 is identified. Although detailed later, the defect coordinate 33 can also be identified without resort to the distance difference image by using the inspection image with the help of the defect coordinate identifying unit 10 and the on contour-line pixel value extraction unit 8.

In step S19, the display control unit 11 causes an image in which the distance difference image and/or defect coordinate 33 are superimposed on the inspection image and/or design pattern image to be displayed on the display unit.

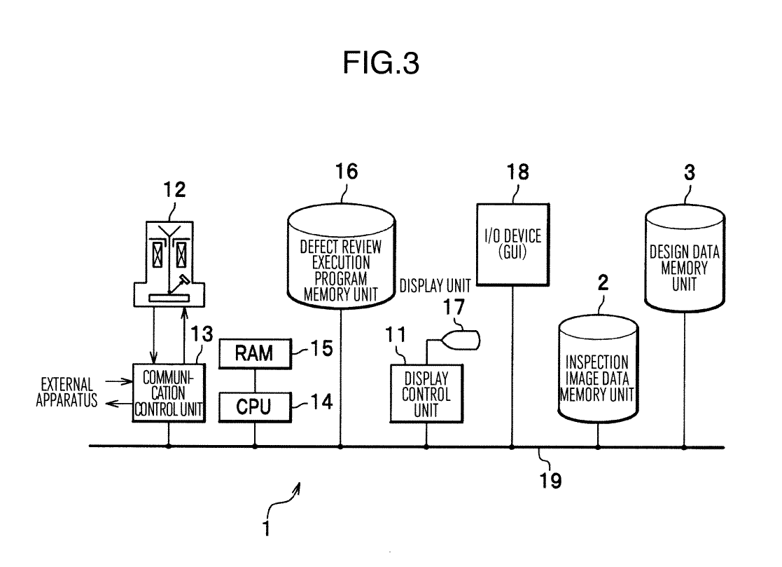

The configuration of the defect review device 1 according to the embodiment of the invention is diagrammatically illustrated in FIG. 3. The defect review device 1 comprises a defect review execution program memory unit 16 stored with a defect review execution program, a CPU 14 and a RAM 15. The defect review execution program is read out of the defect review execution program memory unit 16 to the RAM 15 by way of the CPU 14, ensuring that the CPU 14 can execute the defect review execution program. When the defect review execution program being executed by means of the CPU 14, the CPU 14 can function as VC defect distance inspection image generation unit 4, distance inspection image generation unit 5, distance design image generation unit 6, adder 7, on contour-line pixel value extraction unit 8, distance difference image generation unit 9 and defect coordinate identifying unit 10.

The defect review device 1 also has the display unit 17, the display control unit 11 for controlling the display unit 17, the inspection image data memory unit 2, a design data memory unit 3 and an I/O device 18. The I/O device 18 supports through GUI the operation of defect review device 1 the operator effects.

The defect review device 1 also has an electron microscope 12 and an inspection image picked up by the electron microscope 12 can be stored in the inspection image data memory unit 2 by means of a communication control unit 13. The communication control unit 13 is connected to an external apparatus, specifically an appearance inspection apparatus or a foreign matter inspection apparatus and receives from the appearance inspection apparatus or the like a defect candidate coordinate at which a defect is determined as taking place by means of the appearance inspection apparatus or the like. The electron microscope 12 picks up the defect candidate coordinate inclusive of its neighbor, obtaining an inspection image. As shown in FIG. 3, a bus 19 couples to the communication control unit 13, CPU 14, defect review execution program memory unit 16 and so on to permit mutual communication.

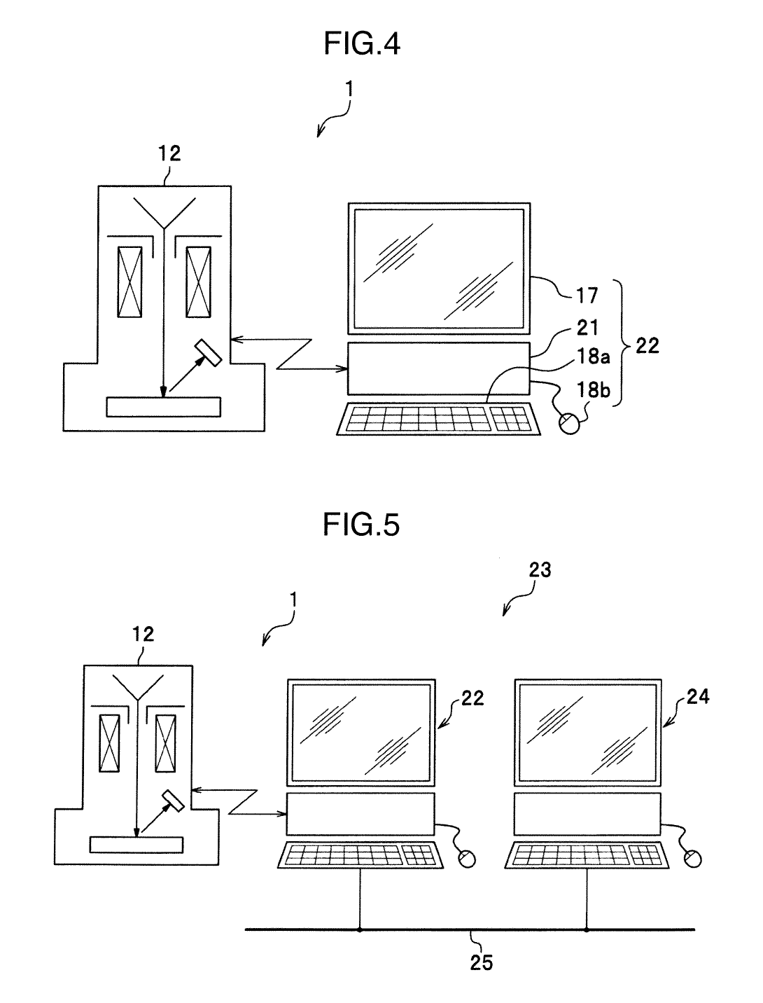

The defect review device 1 according to the embodiment of the invention is illustrated in appearance view form in FIG. 4. In appearance, the defect review device 1 is constructed of the electron microscope 12 and a computer 22 connected to the electron microscope 12. The computer 22 includes the display unit 17, a computer proper 21 and a keyboard 18a and mouse 18b which functions as the I/O device 18. The computer proper 21 has, as shown in FIG. 3, the communication control unit 13, CPU 14, RAM 15, defect review execution program memory unit 16, display control unit 11, inspection image data memory unit 2, design data memory unit 3 and bus 19.

A defect review system 23 according to an embodiment of the invention is configured as shown in FIG. 5. The defect review system 23 has the defect review device 1 and a design data server 24 connected to the defect review device 1 through a network 25. By enabling the design data server 24 to have the design data memory unit 3, the defect review device 1 (computer 22) can dispense with the design data memory unit 3.

### Embodiment 1

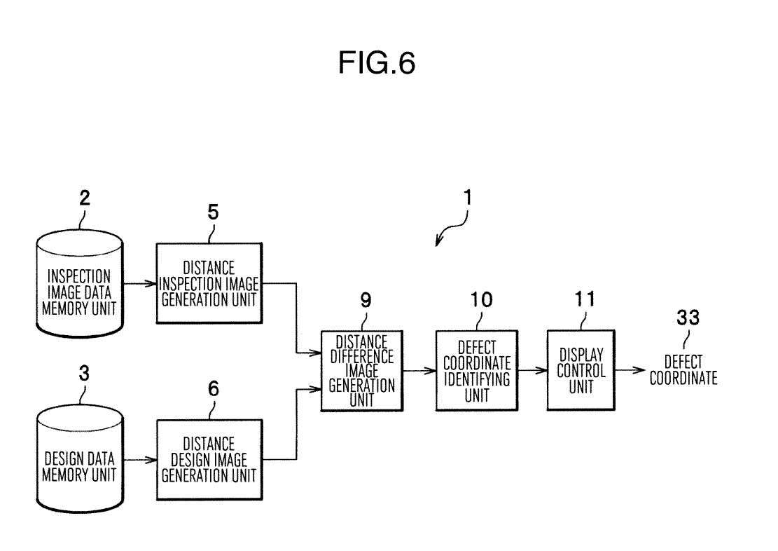

Components necessary for carrying out a defect review method to be explained in embodiment 1 which are extracted from the defect review device 1 are illustrated in block diagram form as shown in FIG. 6. As will be seen from comparison of FIG. 6 with FIG. 1, the VC defect distance inspection image generation unit 4, adder 7 and on contour-line pixel value extraction unit 8 are not used in embodiment 1.

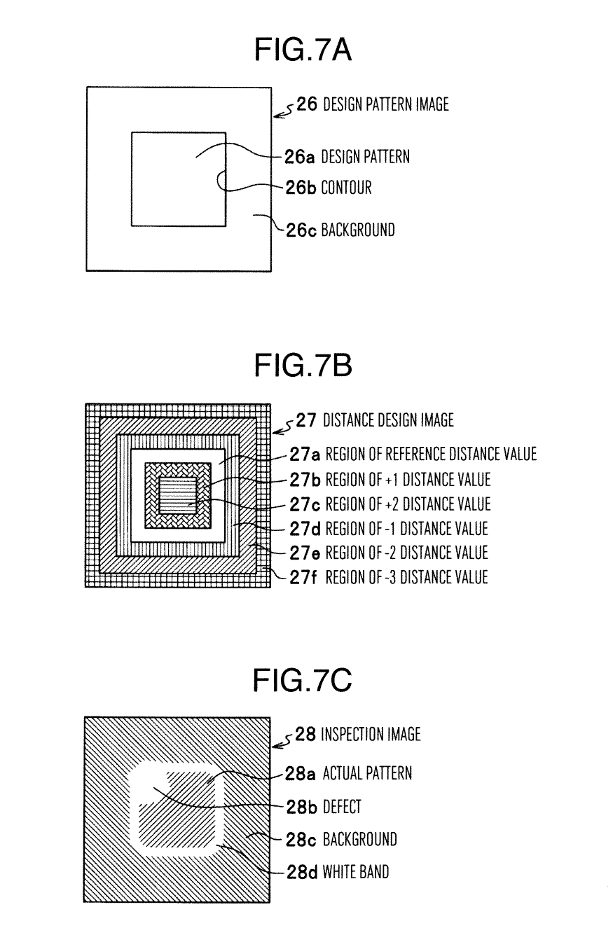

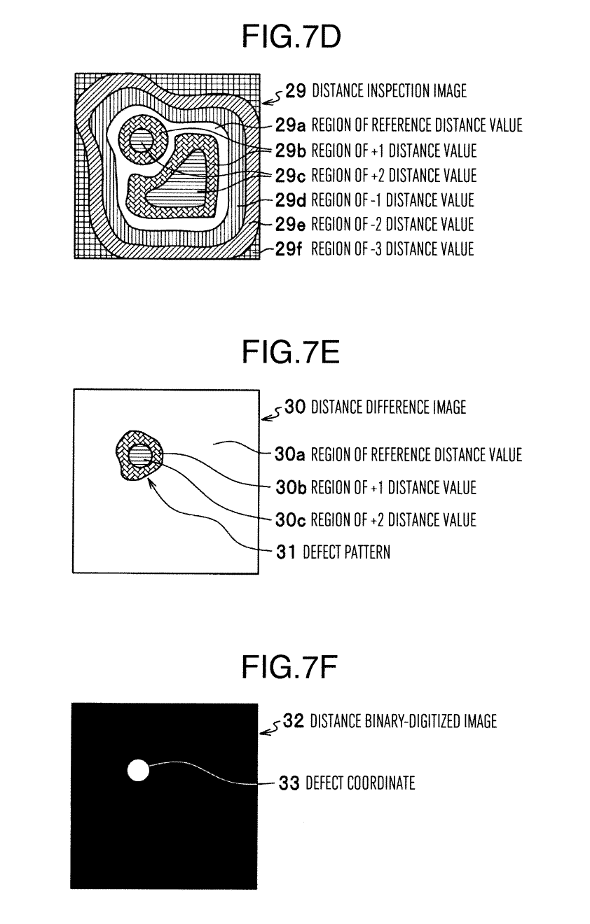

By using FIGS. 7A to 7F, the defect review method in embodiment 1 will be described in general. FIG. 7A shows an example of a design pattern image 26, FIG. 7B shows an example of a distance design image 27, FIG. 7C shows an example of an inspection image 28, FIG. 7D shows an example of a distance inspection image 29, FIG. 7E shows an example of a distance difference image 30 and FIG. 7F shows an example of a distance binary-digitized image 32 in which an extracted defect coordinate 33 is picked up.

Firstly, in the defect review method in embodiment 1, the distance inspection image 29 of FIG. 7D is generated on the basis of the inspection image 28 of FIG. 7C. As shown in FIG. 7C, an actual pattern 28a representing a circuit pattern of a semiconductor device or the like and a background 28c devoid of the actual pattern 28a are photographed in the inspection image 28. Between the actual pattern 28a and the background 28c, a brightly photographed white band 28d exists. Since the actual pattern 28a and the background 28c are different in height, a slant is formed between the actual pattern 28a and background 28c and the slant is photographed in white as the white band 28d. The contour of actual pattern 28a can be set along the white band 28d. In the inspection image 28, a defect 28b is picked up. In the inspection image 28, the defect 28b can be found with ease but practically, the shape of actual pattern 28a is complicated or the defect 28b is picked up in a smaller size and therefore, the operator cannot find at a glance the defect 28b out of the inspection image 28.

FIG. 7D shows the distance inspection image 29 as described previously. The distance inspection image 29 of FIG. 7D will be compared visually with the inspection image 28 of FIG. 7C. In the distance inspection image 29, a region 29a of reference distance values is disposed in which the reference distance values are set to pixels. A region 29b of +1 distance values is disposed internally of the region 29a of reference distance values and a region 29c of +2 distance values is disposed internally of the region 29b of +1 distance values. A region 29d of −1 distance values is disposed externally of the region 29a of reference distance values, a region 29e of −2 distance values is disposed externally of the region 29d of −1 distance values and a region 29f of −3 distance values is disposed externally of the region 29e of −2 distance values.

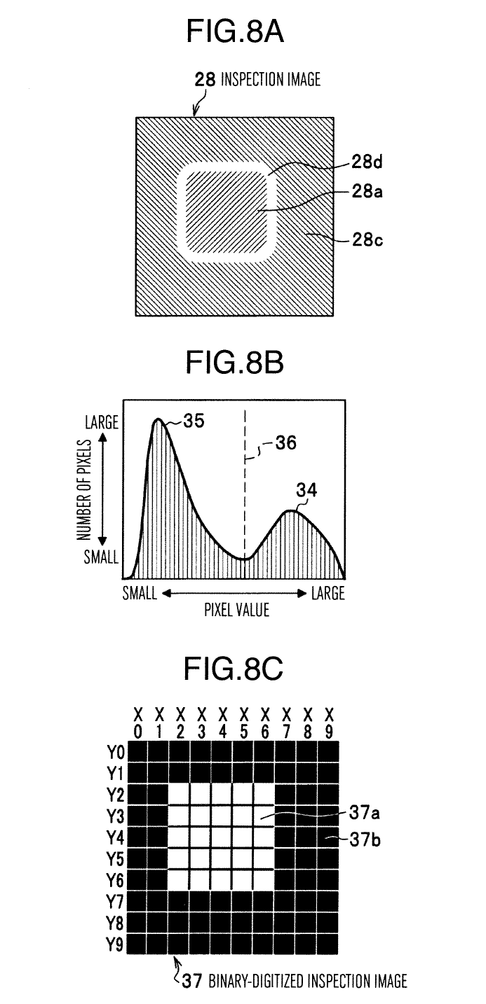

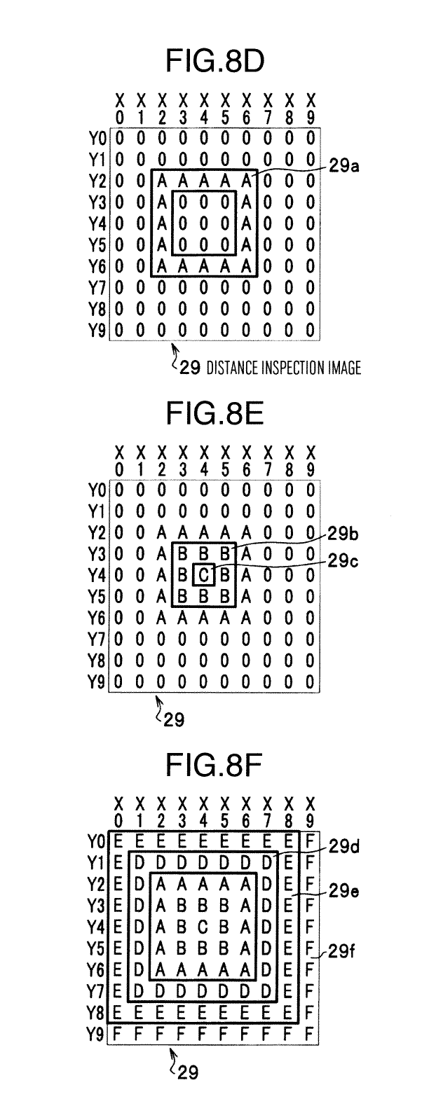

By using FIGS. 8A to 8F, a method of generating a distance inspection image 29 on the basis of the inspection image 28 will be described in detail. FIG. 8A shows an example of the inspection image 28. For better understanding, a defect is not picked up in FIG. 8A. In advance of the step S1 in FIG. 2, the distance inspection image generation unit 5 (see FIG. 1) prepares, as shown in FIG. 8B, a distribution of frequencies (the number of pixels) versus pixel values of individual pixels in the inspection image 28. A peak 34 in the frequency distribution corresponds to the actual pattern 28a and a peak 35 corresponds to the background 28c. A pixel value intervening between the peaks 34 and 35 at which the number of pixels has a substantially minimum value is set to a binary-digitization threshold value 36. It should be understood that specifically, the pixel value corresponds to brightness or the like of a pixel.

As shown in FIG. 8C, the distance inspection image generation unit 5 generates, in the step S1, a binary-digitized image 37 by using the binary-digitization threshold value 36. More specifically, zero is set to pixels whose brightness values do not exceed the binary-digitization threshold value 36 and 1 is set to pixels whose brightness values exceed the binary-digitization threshold value 36, thus performing binary-digitization of the pixels. Pixel values of the pixels can be divided into binary values including values of white indicative of an actual pattern region 37a and values of black indicative of a background region 37b. By making the boundary between actual pattern region 37a and background region 37b the contour of the actual pattern 28a, the contour can be set definitely.

In the step S2, the distance inspection image generation unit 5 initializes the distance inspection image 29 by setting initial values of zero to all pixels of the distance inspection image 29.

As shown in FIG. 8D, the distance inspection image generation unit 5 sets, in the step S3, the contour of actual pattern 28a to the distance inspection image 29 on the basis of the binary-digitized inspection image 37. More specifically, a reference distance value A is set, as a distance value, to pixels positioned at the contour of the distance inspection image 29. By a series of the pixels set with the reference distance value A, a region 29a of the reference distance values can be generated.

In the step S4, the distance inspection image generation unit 5 sets, on the basis of the reference distance value A, distance values to all of residual pixels of distance inspection image 29. As shown in FIG. 8E, a region 29b of +1 distance value B is provided for pixels adjoining the region 29a of reference distance value A internally thereof and a region 29c of +2 distance value C is provided for a pixel adjoining the region 29b of +1 distance value B internally thereof. As shown in FIG. 8F, a region 29d of −1 distance value D is provided for pixels adjoining the region 29a of reference distance value A externally thereof, a region 29e of −2 distance value E is provided for pixels adjoining the region 29d of −1 distance value D, and a region 29f of −3 distance value F is provided for pixels adjoining the region 29e of −2 distance value E externally thereof.

Next, reverting to FIGS. 7A to 7F showing the defect review method of embodiment 1, the process of generating the distance design image 27 of FIG. 7B will be described on the basis of the design pattern image 26 of FIG. 7A. As shown in FIG. 7A, in the design pattern image 26 prepared from design data in the step S11 is sectioned into the design pattern 26a and the background 26c by the contour 26b.

In the step S12, the distance design image generation unit 6 initializes, as in the step S2, the distance design image 27 by setting an initial value of zero to all of the pixels of distance design image 27.

In the step S13, the distance design image generation unit 6 sets, as in the step S3, the contour 26b of design pattern 26a to the distance design image 27. Specifically, the reference distance value A (see FIG. 8D) is set, as distance value, to pixels positioned at the contour 26b in distance design image 27.

As shown in FIG. 7B, in the step S14, the distance design image generation unit 6 sets, as in the step S4, distance values to all of the residual pixels of distance design image 27. A region 27b of +1 distance value is set to pixels adjoining a region 27a of reference distance value internally thereof and a region 27c of +2 distance value is set to pixels adjoining the region 27b of +1 distance value internally thereof. A region 27d of −1 distance value is set to pixels adjoining the region 27a of reference distance value externally thereof, a region 27e of −2 distance value is set to pixels adjoining the region 27d of −1 distance value externally thereof and a region 27f of −3 distance value is set to pixels adjoining the region 27e of −2 distance value externally thereof.

Next, as shown in FIG. 7E, in the step S17, the distance difference image generation unit 9 calculates a difference in distance value between pixels of the distance design image 27 (see FIG. 7B) and pixels corresponding thereto of the distance inspection image 29 (see FIG. 7D) in respect of the individual pixels to thereby generate a distance difference image 30. In the distance difference image 30, a region 30b of +1 distance value and a region 30c of +2 distance value of pixels adjoining the region 30b of +1 distance value internally thereof are generated and these regions represent a defect pattern 31. The remaining region excluding the defect pattern 31 provides a region 30a of reference distance value.

In the step S18, the defect coordinate identifying unit 10 identifies defect coordinate 33 on the basis of the distance difference image 30 and to this end, a distance value of the maximum difference is first extracted from the distance difference image 30. A difference binary-digitization threshold value is set to a value less than a distance value of the extracted difference. By performing binary-digitization of the distance difference image 30 through the use of the difference binary-digitization threshold value, a distance binary-digitized image 32 explicitly illustrating the defect image as shown in FIG. 7F is generated. A coordinate of, for example, the center of the defect image is calculated, providing a defect coordinate 33. As described above, identification of the defect coordinate 33 has ended.

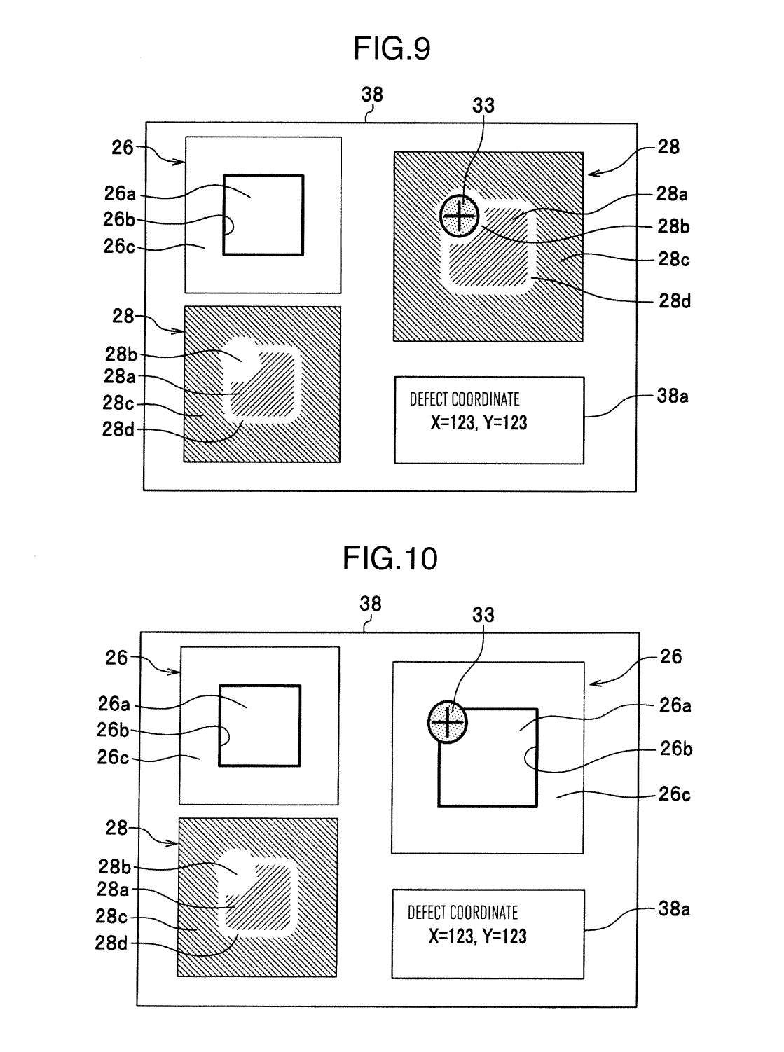

Turning to FIG. 9, a display screen 38 is illustrated which is displayed on the display unit 17 of defect review device 1 (see FIG. 3). In the step S19, the display control unit 17 displays the inspection image 28 left below and the design pattern image 26 left above in the display screen 38. Further, the display control unit 11 causes a numerical value of the defect coordinate 33 to be displayed in a defect coordinate numerical value display region 38a (right below in the display screen 38). As shown in FIG. 9, the display control unit 11 also causes an image in which the defect coordinate 33 is superimposed on the inspection image 28 to be displayed right above in the display screen 38. In place of the defect coordinate 33, the distance difference image 30 (see FIG. 7E) may be superimposed. Alternatively, an image in which the defect coordinate 33 is superimposed on the design pattern image 26 may be displayed on the display screen as shown in FIG. 10. With these display pictures, the operator can identify the defect coordinate easily.

### Embodiment 2

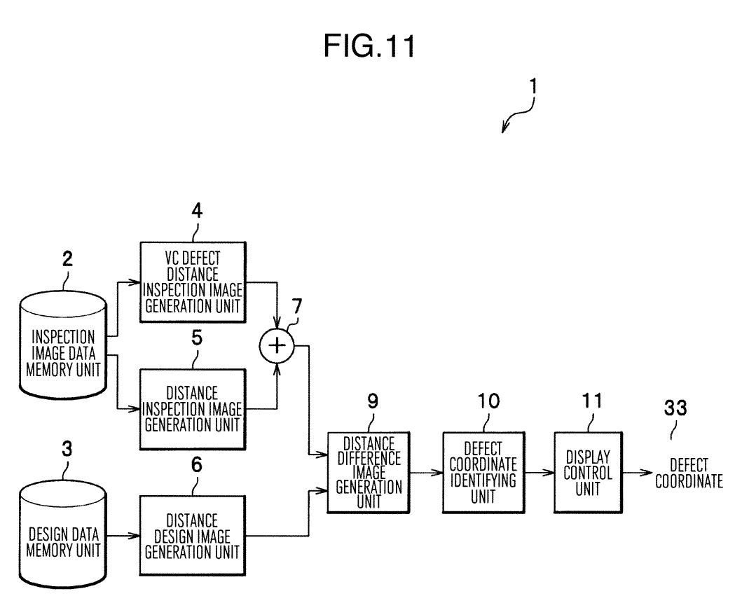

Components necessary for carrying out a defect review method to be explained in embodiment 2 (a defect review method adding, to embodiment 1, VC detection (steps S5 to S10 in FIG. 2) which are extracted from the defect review device 1 are illustrated in FIG. 11 in block diagram form. In comparison with embodiment 1, the VC defect distance inspection image generation unit 4 and the adder 7 are added and the on contour-line pixel value extraction unit 8 is not used in embodiment 2.

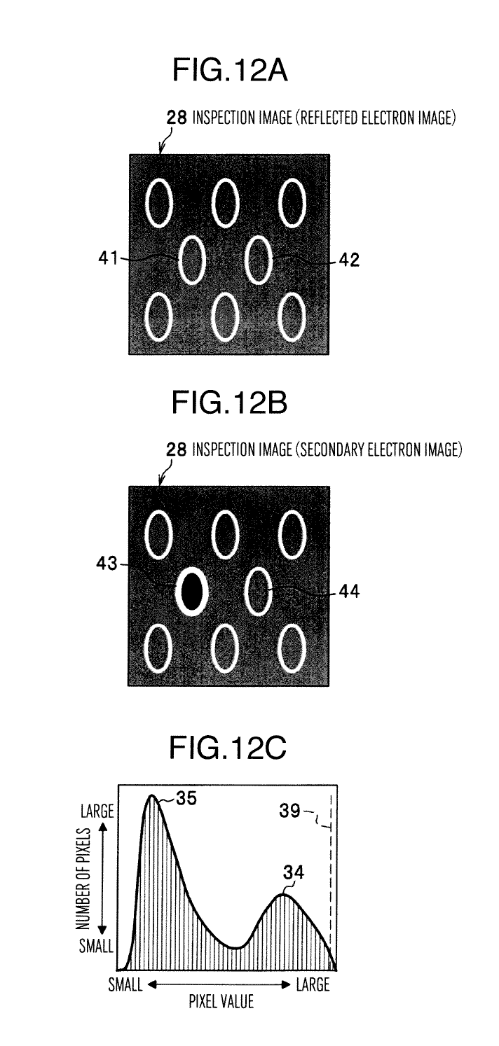

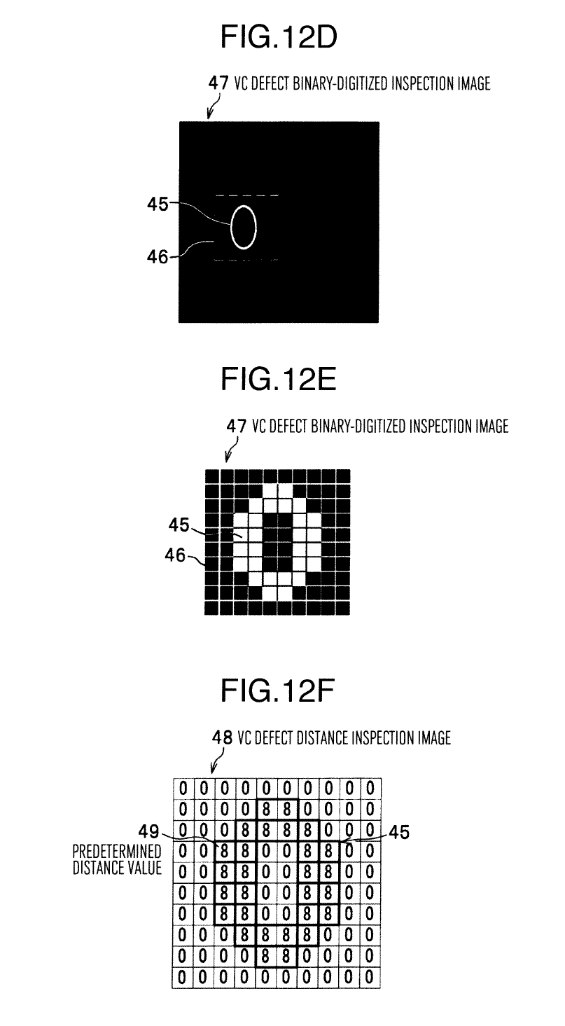

By using FIGS. 12A to 12F, the contents added to embodiment 1 (generation of VC defect distance inspection image and the like) in the defect review method of embodiment 2 will be described. FIG. 12A shows an example of an inspection image 28 in which an actual pattern 41 suffering from a VC defect in the form of a reflected election image and an actual image 42 not suffering from a VC defect are picked up, and FIG. 12B shows an example of an inspection image 28 in which an actual pattern 43 suffering from a VC defect in the form of a secondary electron image and an actual pattern 44 not suffering from a VC defect are picked up. The presence or absence of the VC defect cannot be decided in the reflected electron image in FIG. 12A whereas the presence or absence of the VC defect can be determined in the secondary electron image in FIG. 12B. Then, in advance of the step S5 in FIG. 2, the VC defect distance inspection image generation unit 4 reads the inspection image 28 in the form of a secondary electron image in FIG. 12B out of the inspection image data memory unit 2. The VC defect distance inspection image generation unit 4 prepares a distribution of frequencies of pixel values (the number of pixels) as shown in FIG. 12C in respect of individual pixels in the inspection image 28. A peak 34 in the frequency distribution corresponds to the actual patterns 43 and 44 and a peak 35 corresponds to the background devoid of the actual patterns 43 and 44. A pixel value larger than that at the peak 34 (namely, the pixel is bright (white)) is set as a binary-digitization threshold value 39.

As shown in FIG. 12D, the VC defect distance inspection image generation unit 4 generates a VC defect binary-digitized image 47 in the step S5 by using the binary-digitization threshold value 39. The pixel value of pixel can be divided into binary values including a value of white of the VC defect pattern 45 and a value of black of the other region. AVC defect binary-digitized inspection image 47 in which pixels are diagrammatically illustrated by enlarging an enlargement window 46 to emphasize pixels is illustrated in FIG. 12E.

In the step S6, the VC defect distance inspection image generation unit 4 initializes a VC defect distance inspection image 48 by setting an initial value of zero to all pixels of the VC defect distance inspection image 48.

In the step S7, the VC defect distance inspection image generation unit 4 extracts, on the basis of the VC defect binary-digitized inspection image 47, pixels corresponding to an actual pattern 43 (VC defect pattern 45) having a difference in potential contrast from other actual patterns in the VC defect distance inspection image 48.

As shown in FIG. 12F, the VC defect distance inspection image generation unit 4 sets, in the step S8, “8” as predetermined distance value 49 to the extracted pixels. It should be understood that the predetermined distance value 49 is set to be larger than the difference binary-digitization threshold value explained in connection with the step S18.

In the step S9, the adder 7 performs, on the basis of the inspection image 28, position matching between the distance inspection image 29 (see FIG. 8F) and the VC defect distance inspection image 48.

In the step 10, the adder 7 adds a distance value of a corresponding pixel of the VC defect distance inspection image 48 to a distance value of each pixel of the distance inspection image 29 (addition) to thereby update (correct) the distance inspection image 29. The ensuing procedures can be executed as in the step S11 and ensuing steps in embodiment 1.

### Embodiment 3

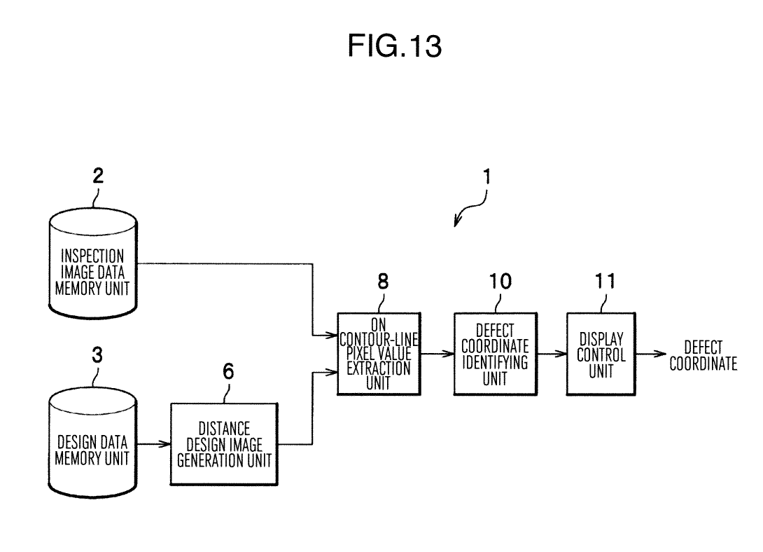

Components necessary for carrying out a defect review method to be explained in embodiment 3 (identifying a defect coordinate 33 by detecting pixel values on a contour line of distance values) which are extracted from the defect review device 1 are illustrated in block diagram form as shown in FIG. 13. In embodiment 3, the defect coordinate 33 is identified by using the on contour-line pixel value extraction unit 8.

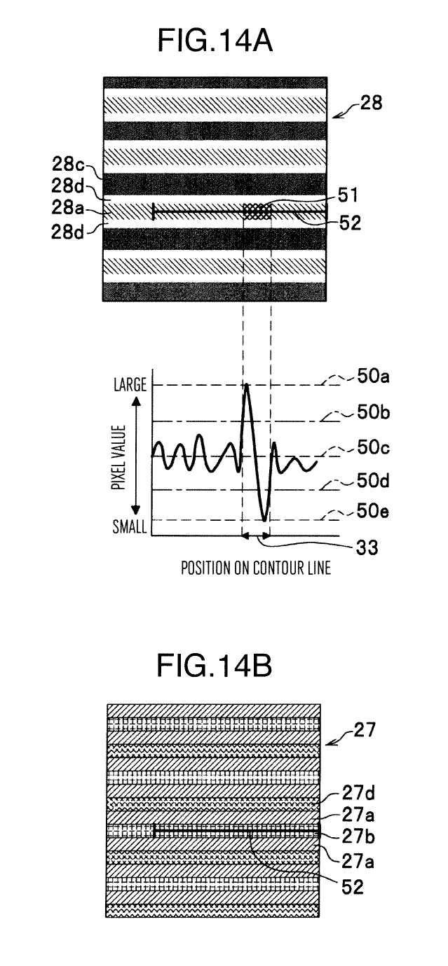

By using FIG. 14A and FIG. 14B, the defect review method of embodiment 3 will be described. Illustrated in FIG. 14A is an inspection image 28 in which line and space are picked up. The line corresponds to an actual pattern 28a and the space corresponds to a background 28c. A defect 51 takes place on a line of the actual pattern 28a. In such a case, the defect 51 cannot be detected by even using a distance value. Then, in advance of the step S18 in FIG. 2, a contour line 52 of distance values is set in a distance design image 27 as shown in FIG. 14B generated by the distance design image generation unit 6. The contour line 52 is set on consecutive pixels of equidistant values as in a region 27b of +1 distant value. As shown in FIG. 14A, a contour-line 52 is also set throughout positions in inspection image 28 corresponding to positions of contour line 52 in the distance design image 27. As shown in a waveform diagram in FIG. 14A, pixel values in inspection image 28 corresponding to the positions on the contour line 52 change largely at the defect 51. Pixels positioned at the defect 51 are brightened/darkened as compared to other pixels. The on contour-line pixel extraction unit 8 determines an average value 55 of pixel values on the contour-line 52 pursuant to the following equation and determines a maximum value 50a and a minimum value 50e of the pixel values on the contour-line 52.

Average value=sum of pixel values on contour-line/the number of pixels

Subsequently, an intermediate value between average value 50c and maximum value 50a (=(average value+maximum value)/2) is defined as an upper threshold value 50b and an intermediate value between average value 50c and minimum value 50e (=(average value+minimum value)/2) is defined as a lower threshold value 50d. Then, the defect coordinate 33 is identified by an interval which ranges from a position where a pixel value larger than the upper threshold value 50b is detected to a position where a pixel value smaller than the lower threshold value 50d is detected and a position as well where a pixel value in excess of the lower threshold value is thereafter detected.

In embodiment 3, the distance design image generation unit 6 is used as shown in FIG. 13 but the distance inspection image generation unit 5 may substitute for it. In this case, the contour-line 52 in FIG. 14B is set in a distance inspection image 29 substituting for the distance design image 27.

### Embodiment 4

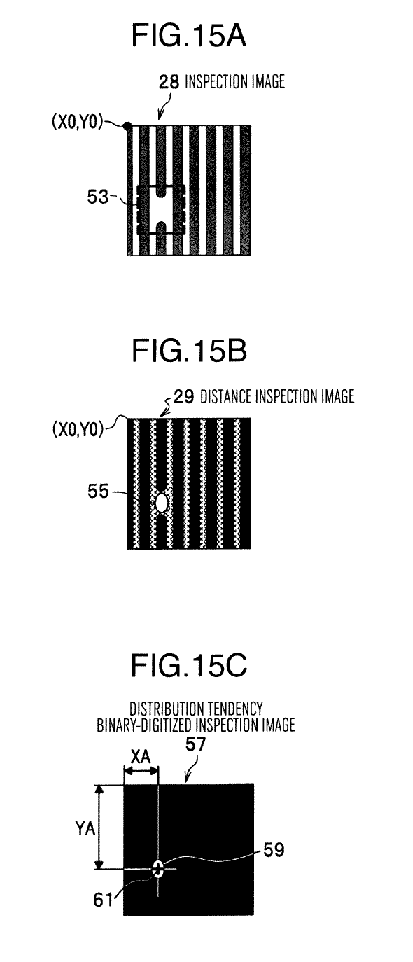

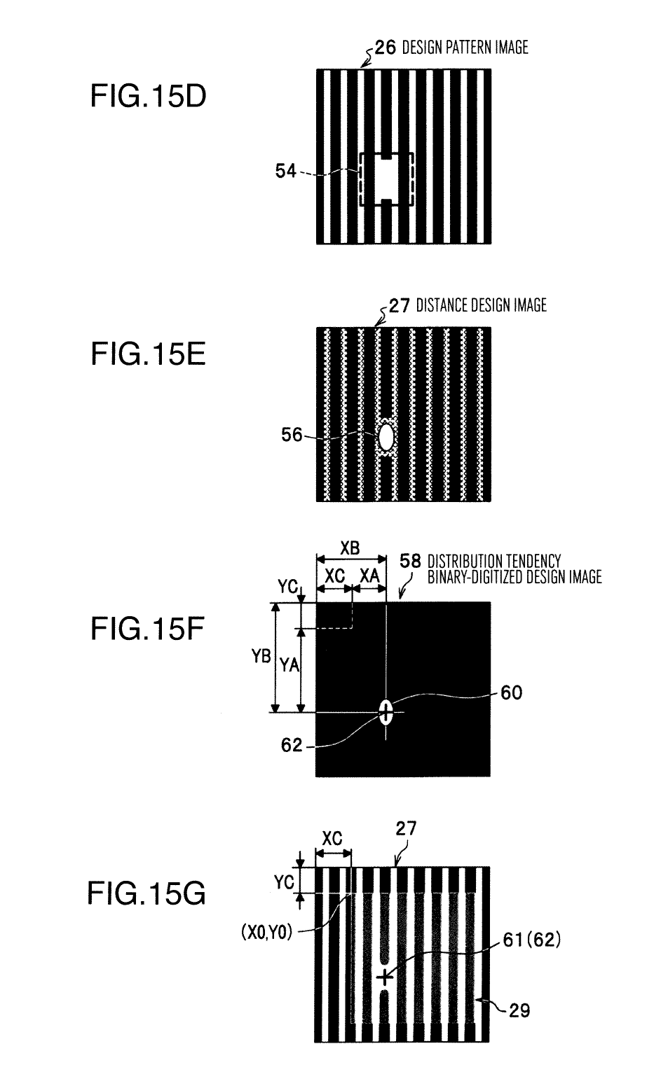

By using FIGS. 15A to 15G, embodiment 4 will be described by giving a detailed description of the position matching in step S16 of FIG. 2 in the defect review method. The position matching is carried out before the generation of a distance difference image 30 in the step S17. An example of an inspection image 28 is illustrated in FIG. 15A. An origin (X0, Y0) is set left above in the inspection image 28. The inspection image 28 has a pattern 53 having features. A distance inspection image 29 corresponding to the inspection image of FIG. 15A is illustrated in FIG. 15B. In the distance inspection image 29, a region 55 takes place which corresponds to the pattern 53 having features and the magnitude of distance value differs from that in the other region. As shown in FIG. 15C, to make the region 55 in FIG. 15B a region 59 which is discriminative from the other region, a binary-digitization threshold value is set and by using the binary-digitization threshold value, a distribution tendency binary-digitized inspection image 57 is generated. A center coordinate (XA, YA) 61 of region 59 can be determined. The region 59 and its center coordinate (XA, YA) 61 are deemed as indicating a tendency toward the distribution of distance values in the distance inspection image 29.

Illustrated in FIG. 15D is a design pattern image 26 corresponding to the inspection image 28 of FIG. 15A. The design pattern image is acquired in a size being equal to that of the inspection image 28 or in a size being larger than that of the inspection image 28. This is because even when the defect candidate coordinate displaces from the defect coordinate 33, all pixels on the distance inspection image 29 can be allowed to align with pixels on the distance design image 27. Then, like the inspection image 28, the design pattern image 26 also has a pattern 54 having features.

Illustrated in FIG. 15E is a distance design image 27 corresponding to the design pattern 26 of FIG. 15D. In the distance design image 27, a region 56 takes place which corresponds to the pattern 54 having features and the magnitude of distance value differs from that of the other region. As shown in FIG. 15F, in order that the region 56 of FIG. 15E is made to be a region 60 which is discriminative from the other region, a binary-digitization threshold value is set and by using the binary-digitization threshold value, a distribution tendency binary-digitized design image 58 is generated. A center coordinate (XB, YB) 62 of region 60 can be determined. The region 60 and its center coordinate (XB, YB) 62 are deemed as indicating a tendency toward the distribution of distance values in the distance design image 27. In order to perform the position matching such that a tendency of an increase/decrease distribution of distance values in the distance design image 27 aligns and coincides with a tendency of an increase/decrease distribution of distance values in the distance inspection image 29, the center coordinate (XA, YA) 61 is made to be coincident with the center coordinate (XB, YB) 62. For coincidence, the origin (X0, Y0) may be set on the coordinate (XC, YC) in distance design image 27 and distribution tendency binary-digitized design image 58 as well (here, XC=XB−XA, YC=YB−YA).

### Embodiment 5

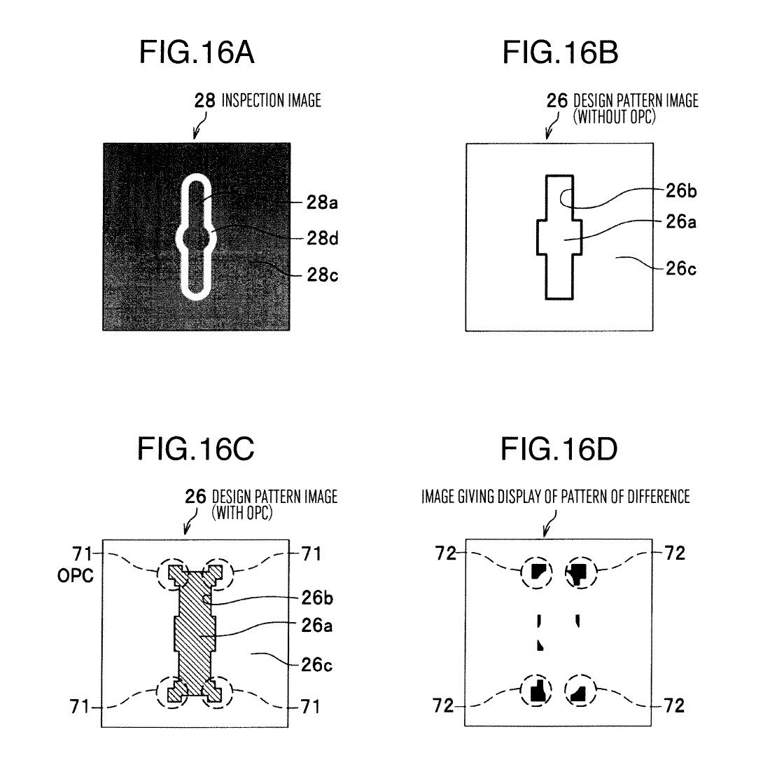

By using FIGS. 16A to 16D, the reason why an erroneous defect coordinate 33 is identified when design data with optical proximity correction (OPC) is used will be described. Illustrated in FIG. 16A is an example of an inspection image 28 in which an actual pattern 28a is picked up. Illustrated in FIG. 16B is a design pattern image 26 without OPC. It will be seen that the actual pattern 28a on the inspection image 28 fairly coincides with the design pattern 26a on the design pattern image 26. Illustrated in FIG. 16C is a design pattern image 26 with OPC 71. FIG. 16D shows a pattern 72 indicative of a difference between the actual pattern 28a and the design pattern 26a with OPC 71. The OPC 71 is displayed as the difference pattern 72 and will be erroneously recognized as a defect in some case. Therefore, the step S15 needs to be provided also in advance of the generation of a distance difference image 30 in the step S17 to eliminate the optical proximity correction (OPC).

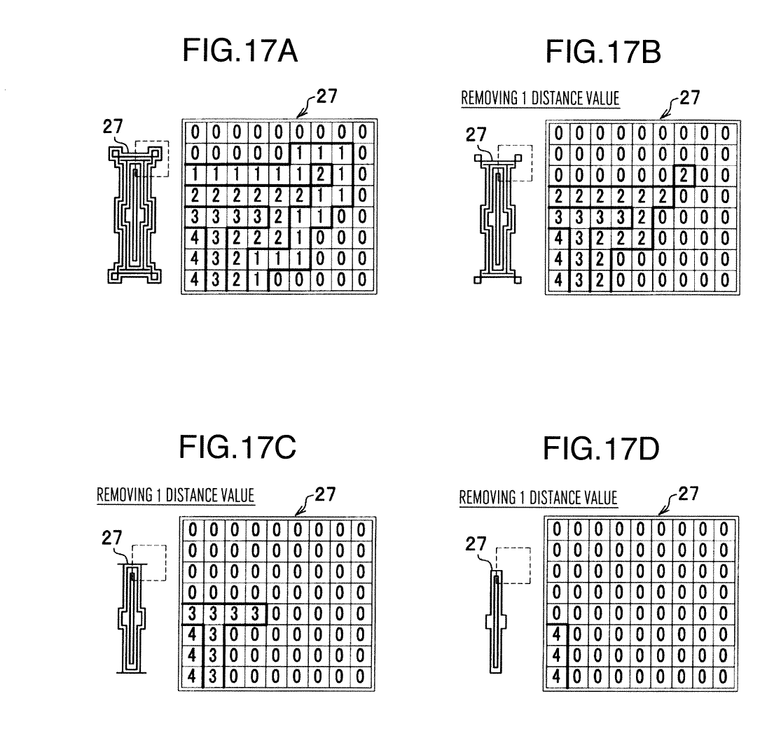

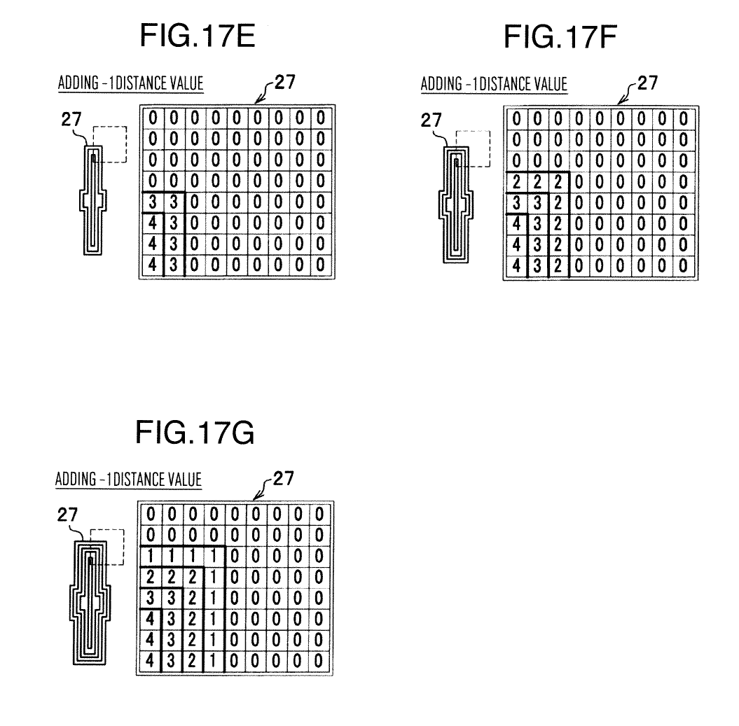

In embodiment 5, elimination of the OPC in the step S15 in the defect review method will be described in detail with reference to FIGS. 17A to 17G. FIG. 17A shows a distance design image 27 based on the design pattern image 26 of FIG. 16C. A reference distance value of zero is set to pixels lying on the contour of the design pattern. For better understanding, zero equaling the reference distance value is also set to pixels external of the contour of design pattern.

Next, as shown in FIG. 17B, the zero reference value is set to pixels (set with 1 distance value) one distance value internal of the pixels set with the zero reference distance value in the distance design image 27 of FIG. 17A. It can be considered by this that 1 distance value set to the pixel one pixel internal of the pixel set with the zero reference distance value is reduced by 1 distance value so as to be set to the zero distance value.

By repeating this, as shown in FIG. 17C, the zero reference value is set to pixels (set with 2 distance value) one distance value internal of the pixels set with the zero reference distance value in the distance design image 27 of FIG. 17B. It can be considered by this that 2 distance value set to the pixel one pixel internal of the pixel set with the zero reference distance value is reduced by 2 distance value so as to be set to zero reference distance value.

Further, as shown in FIG. 17D, the zero reference value is set to pixels (set with 3 distance value) one distance value internal of the pixels set with the zero reference distance value in the distance design image 27 of FIG. 17C. It can be considered by this that 3 distance value set to the pixel one pixel internal of the pixel set with the zero reference distance value is reduced by 3 distance value so as to be set to the zero reference distance value. Thus, the OPC can be eliminated.

Next, as shown in FIG. 17E, the 3 distance value which is 1 distance value smaller than the 4 distance value of the one pixel internal pixel is set to the innermost ones of the pixels set with the zero reference distance value in the distance design image 27 of FIG. 17D. By this setting, the OPC eliminated status can also be maintained. It can also be considered by this setting that the innermost ones of pixels set with the zero reference distance value are increased in distance value by 3 distance value which is 1 distance value smaller than the 4 distance value of the one pixel internal pixel.

By repeating this, as shown in FIG. 17F, the 2 distance value which is 1 distance value smaller than the 3 distance value of the one pixel internal pixel is set to the innermost ones of the pixels set with the zero reference distance value in the distance design image 27 of FIG. 17E. By this setting, the OPC eliminated status can also be maintained. Then, it can be considered by this setting that the innermost ones of pixels set with the zero reference distance value are increased in distance value by 2 distance value which is 1 distance value smaller than the 3 distance value of the one pixel internal pixel.

Finally, as shown in FIG. 17Q the 1 distance value which is 1 distance value smaller than the 2 distance value of the one pixel internal pixel is set to the innermost ones of the pixels set with the zero reference distance value in the distance design image 27 of FIG. 17F. By this setting, the OPC eliminated status can also be maintained. Then, it can be considered by this setting that the innermost ones of pixels set with the zero reference distance value are increased in distance value by 1 distance value which is 1 distance value smaller than the 2 distance value of the one pixel internal pixel. In this manner, at the time that the distance value to be set or added equals the 1 distance value which is the minimal unit of distance value, the elimination of OPC in step S15 may be ended.

The foregoing description is given of the embodiments but the present invention is not limited thereto and it is obvious to those skilled in the art that the present invention can be altered and modified in various ways within the framework of the spirit of the invention and the appended claims.

### REFERENCE SIGNS LIST

1 Defect review device
2 Inspection image data memory unit
3 Design data memory unit
4 VC defect distance inspection image generation unit
5 Distance inspection image generation unit
6 Distance design image generation unit
7 Adder
8 On contour-line pixel value extraction unit
9 Distance difference image generation unit
10 Defect coordinate identifying unit
11 Display control unit
12 Electron microscope
13 Communication control unit
26 Design pattern image
26a Design pattern
26b Contour
26c Background
27 Distance design image
28 Inspection image
28a Actual pattern
28b Defect
28c Background
28d White band
29 Distance inspection image
30 Distance difference image
31 Defect pattern
32 Distance binary-digitized image
33 Defect coordinate
34, 35 Peak
36 Binary-digitization threshold value
37 Binary-digitized inspection image
37a Actual pattern portion
37b Background portion
45 VC defect pattern
46 Enlargement window
47 VC defect distance inspection image
52 Contour line

1. A defect review device comprising:
a distance inspection image generation unit for generating, on the basis of an inspection image, a distance inspection image in which distance values between pixels constituting the contour of an actual pattern and pixels lying in a direction normal to the contour are set in respect of the individual pixels;
a distance design image generation unit for generating a distance design image in which values between pixels constituting the contour of a design pattern corresponding to said actual pattern and pixels lying in a direction normal to the contour are set in respect of the individual pixels;
a distance difference image generation unit for generating a distance difference image in which differences in distance value between the distance design image and the distance inspection image are set in respect of the individual pixels; and
a defect coordinate identifying unit for identifying, on the basis of the distance difference image, a defect coordinate at which a defect takes place.

2. A defect review device according to claim 1, wherein:
said distance inspection image generation unit sets the distance value to a pixel of the distance inspection image;
said distance design image generation unit sets the distance value to a pixel of the distance design image in a range equal to or wider than the distance inspection image; and
said distance difference image generation unit performs, in advance of generation of the distance difference image, position matching between the distance design image and the distance inspection image.

3. A defect review device according to claim 1, further comprising an on contour-line pixel value extraction unit for extracting pixel values of pixels in the inspection image corresponding to consecutive pixels of equidistant value in the distance design image, wherein
said defect coordinate identifying unit identifies the defect coordinate on the basis of the extracted pixel value.

4. A defect review device according to claim 1, wherein said distance difference image generation unit performs, in advance of generation of the distance difference image, position matching between the distance design image and the distance inspection image such that a tendency of an increase/decrease distribution of distance values in the distance design image aligns and coincides with a tendency of an increase/decrease distribution of distance values in the distance inspection image.

5. A defect review device according to claim 1, further comprising:
a VC defect distance inspection image generation unit for extracting, on the basis of the inspection image, a pixel corresponding to an actual pattern being different in potential contrast from another actual pattern and for generating a VC defect distance inspection image in which a predetermined distance value is set to the extracted pixel; and
an adder for adding the distance value of the VC defect distance inspection image to the distance value of the distance inspection image so as to update the distance inspection image.

6. A defect review device according to claim 1, wherein said actual pattern is a pattern of a semiconductor device.

7. A defect review device according to claim 1, wherein said distance design image generation unit resets the distance value of the distance design image by decreasing the distance value and thereafter increasing it in order to eliminate the optical proximity correction in the distance design image.

8. A defect review device according to claims 1, further comprising a display control unit for causing the distance difference image and/or the defect coordinate to be superimposed on the inspection image and/or the design pattern image and for displaying the resulting image on the display unit.

9. A defect review method wherein
a distance inspection image is generated in which distance values between pixels constituting the contour of an actual pattern and pixels lying in a direction normal to the contour are set on the basis of an inspection image in respect of the individual pixels;
a distance design image is generated in which distance values between pixels constituting the contour of a design pattern corresponding to the actual pattern and pixels lying in a direction normal to the contour are set in respect of the individual pixels;
a distance difference image is generated in which differences in the distance values between the distance design image and the distance inspection image are set in respect of the individual pixels; and
a defect coordinate at which a defect takes place is identified on the basis of the distance difference image.

10. A defect review execution program for causing a computer to execute:
a procedure for generating a distance inspection image in which distance values between pixels constituting the contour of an actual pattern and pixels lying in a direction normal to the contour are set on the basis of an inspection image in respect of the individual pixels;
a procedure for generating a distance design image in which distance values between pixels constituting the contour of a design pattern corresponding to the actual pattern and pixels lying in a direction normal to the contour are set in respect of the individual pixels;
a procedure for generating a distance difference image in which differences in the distance values between the distance design image and the distance inspection image are set in respect of the individual pixels; and
a procedure for identifying, on the basis of the distance difference image, a defect coordinate at which a defect takes place.
